(19) United States
(12) Patent Application Publication
(10) Pub. No.: US 2015/0155010 A1
(43) Pub. Date: Jun. 4, 2015

(54) METHOD FOR RETRIEVING INFORMATION, PROCESSING UNIT AND MEDICAL IMAGING SYSTEM

(71) Applicant: Siemens Aktiengesellschaft, Munich (DE)

(72) Inventor: Gerhard KRAEMER, Igensdorf (DE)

(21) Appl. No.: 14/557,558

(22) Filed: Dec. 2, 2014

(30) Foreign Application Priority Data
Dec. 4, 2013 (DE) 102013224888.1

(51) Int. Cl. G11B 31/00; G06F 19/00; G06F 3/0482; G11B 27/34; G11B 27/00

(52) U.S. Cl. CPC G11B 31/006; G11B 27/34; G11B 27/002; G06F 3/0482; G06F 19/321

(57) ABSTRACT

A method is disclosed for retrieving information about a medical image presented at a user interface of a processing unit of the medical imaging system. In at least one embodiment, the method includes: display of a reference to at least one video stored on the processing unit and integrated into the user interface; activation of the reference and selection of the video by a user and playing of the video. The video contains demand-specific and context-related information and/or operating instructions for the user. A processing unit of a medical imaging system is also disclosed. In an embodiment, it includes a memory unit and program code stored in the memory unit. The program code is embodied such that a medical image of the patient is output at the user interface of the processing unit.

### PRIORITY STATEMENT

The present application hereby claims priority under 35 U.S.C. §119 to German patent application number DE 102013224888.1 filed Dec. 4, 2013, the entire contents of which are hereby incorporated herein by reference.

### FIELD

At least one embodiment of the invention generally relates to a method for retrieving information relating to a medical image presented at a user interface of a processing unit of a medical imaging system. At least one embodiment of the invention further generally relates to a processing unit of a medical imaging system, at least comprising a memory unit and program code stored in the memory unit, wherein the program code is embodied such that a medical image of a patient is output at a user interface of the processing unit, and to a medical imaging system.

### BACKGROUND

Image diagnosis programs such as the “syngo.via” program developed by the applicant or other post-processing applications for imaging medical examination systems, such as CT or MRT systems for example, provide the user with a large number of functions. In a wide diversity of situations the user must know which functions are basically able to be executed in the respective situation, and with very complex functions or tools in particular, must know how these are to be applied.

In the following situations the provision of knowledge about the examination system is of particular importance:

Untrained users must be able to have an overview of all functions of the examination system in order to familiarize themselves with its applications. For this purpose a series of new functions, tools and their application, such as corner menus, workflow mapping etc., must be imparted to the untrained user. Since users frequently switch between examination systems, again and again they encounter the situation of having to learn the functions of a further examination system.

Currently there are essentially two options for the untrained user to overcome these initial difficulties. The user can either participate in a familiarization training course lasting several days or can read through comprehensive written documentation of the examination system in order to be informed of all functions and their application. Both options are enormously time-consuming. Furthermore there are comprehensive videos with which the user can obtain information about an examination system. However viewing these videos is likewise time-consuming and the videos are kept very general. They seldom relate to real problems encountered in the actual context, for example tips for drawing a center line through a stenosis.

Another situation in which knowledge about the examination system has to be imparted occurs if a new, changed version of an image diagnosis program comes onto the market. In most cases release documents are issued for this. These documents are technically formulated and primarily give information about corrected errors. New functions are only mentioned in passing and the new functions are not adequately described from the user's standpoint. Therefore these documents are generally not read. As a result the effort of creating a release document is largely made in vain.

Furthermore advanced users of an image diagnosis program are also to be provided with specific knowledge about complex tools and functions of the examination system. For this purpose the advanced users must either spend a lot of time finding their way around the examination system or the program or have the corresponding applications shown to them by other experts.

Finally it is also necessary, in the event of an error, to provide functions and ways in which the error can be rectified by the user. Sometimes it is tedious and time-consuming for a user to rectify an error himself since the errors are often very context-specific and very possibly are not described in general documentation. Therefore as a rule the user resorts to a hotline set up by the manufacturer of the examination system or of the image diagnosis program. This is however likewise very time-consuming for the user.

### SUMMARY

at least one embodiment of the invention provides a method for retrieval of demand-specific and context-related information about an image diagnosis program, through which knowledge relating to functions and applications of the examination system can be imparted easily and quickly. At least one further embodiment of the invention is directed to a processing unit, and an a further one to a medical imaging system.

Advantageous developments of the invention are the subject matter of dependent claims.

Accordingly, in at least one embodiment, the inventor proposes a method for retrieving information for a medical image presented at the user interface of the processing unit of a medical imaging system, at least comprising:
displaying a reference to at least one video stored on the processing unit and integrated into the user interface,
activation of the reference, and
selection of the video by a user and playing of the video, wherein the video contains specific demand-specific and context-related information and/or operating instructions for the user.

The inventor, in at least one embodiment, further proposes improving a processing unit of a medical imaging system, especially of a CT system or an MRT system, at least comprising a memory unit and program code stored in the memory unit, wherein the program code is designed such that a medical image of a patient is output at a user interface of the processing unit, to such an extent that at least one embodiment of the inventive method described herein is able to be executed.

Finally the inventor proposes a medical imaging system, especially a CT system or an MRT system at least having an inventive processing unit described herein.

### BRIEF DESCRIPTION OF THE DRAWINGS

The invention is explained in greater detail below with reference to an example embodiment with the aid of the figures, wherein only the features necessary for understanding the embodiments of invention are presented. The following reference characters are used: 1: User interface; 2: Toolbar; 3a to 3c: Windows; 4: Presentation of the working steps; 5: Area for playing the videos; 6: Subtitle; 7: Pointer; A1 to A4: Different views of a medical image of an examination object; i: Information symbol; T1 to T4: Tools; V1 to V4: Available videos.

In the individual figures:

FIG. 1: shows a schematic diagram of a first step of an embodiment of the inventive method for retrieval of information at a user interface;

FIG. 2: shows a schematic diagram of a further step of an embodiment of the inventive method;

FIG. 3: shows a schematic diagram of a further step of an embodiment of the inventive method; and

FIG. 4: shows a schematic diagram of a further step of an embodiment of the inventive method.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

Before discussing example embodiments in more detail, it is noted that some example embodiments are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed below, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks will be stored in a machine or computer readable medium such as a storage medium or non-transitory computer readable medium. A processor(s) will perform the necessary tasks.

Specific structural and functional details disclosed herein are merely representative for purposes of describing example embodiments of the present invention. This invention may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the example embodiments and corresponding detailed description may be presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the following description, illustrative embodiments may be described with reference to acts and symbolic representations of operations (e.g., in the form of flowcharts) that may be implemented as program modules or functional processes include routines, programs, objects, components, data structures, etc., that perform particular tasks or implement particular abstract data types and may be implemented using existing hardware at existing network elements. Such existing hardware may include one or more Central Processing Units (CPUs), digital signal processors (DSPs), application-specific-integrated-circuits, field programmable gate arrays (FPGAs) computers or the like.

Note also that the software implemented aspects of the example embodiments may be typically encoded on some form of program storage medium or implemented over some type of transmission medium. The program storage medium (e.g., non-transitory storage medium) may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The example embodiments not limited by these aspects of any given implementation.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” of “displaying” or the like, refer to the action and processes of a computer system, or similar electronic computing device/hardware, that manipulates and transforms data represented as physical, electronic quantities within the computer system's registers and memories into other data similarly represented as physical quantities within the computer system memories or registers or other such information storage, transmission or display devices.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

The inventor has recognized that the knowledge about functions, applications and/or error handling involving an examination device can be provided easily and quickly by means of context-specific and demand-oriented videos in an image diagnosis program. The videos are integrated into a user interface and are able to be retrieved on demand by the user. These videos do not just focus on describing individual tools and functions per se, but provide the knowledge oriented to the respective specific application case. For example an explanation is provided in a video as to with which tools, interactions and in which segments a center line can be easily drawn through a stenosis.

The videos can be displayed and provided easily at the user interface. It is especially convenient for the user if the videos are only opened and played if directly selected by the user, for example with the pointer of a computer mouse, and are thus not displayed in the foreground of the user interface. So-called still references on the respective working surfaces can notify the user about the availability of videos and, if required, provide him with access to a structured listing of all available videos. The notifications can be displayed for example in the form of i-symbols.

The videos can be embedded in different areas of the user interface and displayed differently. For example an information symbol or icon can be displayed in the different work areas and thus signal that videos are available for the respective theme of the working area. By selecting the icon the user can play the video or select a video from a number of available videos and explicitly play said video. Furthermore information symbols about the availability of videos can be seen in a mini toolbar of the user interface. A mini toolbar is a collection of tools for a specific subtask, for example for measuring stenoses or aneurisms. An information icon in the mini toolbar can show that available videos, which could be useful to the user under some circumstances, exist for the respective tools on the mini toolbar.

Videos can also impart the necessary required knowledge and information within the context of error messages and the rectification of the errors notified in a simple manner. If for example the examination system outputs an error message for which the resolution is already known, a reference to an available video can be displayed in the error message. The video can then contain all steps necessary for rectifying the error, for example also any background information with which a renewed error message can be avoided if possible.

Furthermore a video or just a reference to available videos can be displayed in a context menu for a specific function, for example an information symbol within a specific segment or in a special video or training area within the user interface or as an active information displayed as a video reference.

For imparting information simply and completely it is sensible to indicate in the videos a description of all working steps which are necessary to achieve a respective substep or a subtask. Likewise reproducing background information about the examination system or about the respective application or an error and also references for further possible solutions is sensible.

It is also sensible to design the videos to be as simple and as short as possible, so that the user can acquire complete knowledge in a simple manner end in the shortest possible time regarding a function or an application. To this end a video is 60 to 90 s long for example. Naturally the user would feel that even shorter videos were even better, wherein a balance has to be struck between imparting the fullest information possible and a shortest possible running time of the video.

In a video both the initial situation and problem and also each substep can be explained in an easy-to-understand manner for the user, for example without technical terms but colloquially and in a positive, motivating and friendly-sounding voice. Furthermore subtitles enable the video to be played without sound if this is felt to be disruptive or there is no opportunity for the sound to be played.

Accordingly, in at least one embodiment, the inventor proposes a method for retrieving information for a medical image presented at the user interface of the processing unit of a medical imaging system, at least comprising:
displaying a reference to at least one video stored on the processing unit and integrated into the user interface,
activation of the reference, and
selection of the video by a user and playing of the video, wherein the video contains specific demand-specific and context-related information and/or operating instructions for the user.

The image diagnosis program is used for evaluating medical images of an imaging examination system, for example of an MRT system or CT system. With the aid of the inventive videos of at least one embodiment, the user can learn in a simple manner how to handle an image diagnosis program or expand his knowledge about the image diagnosis program and its functions. Preferably general or specific operating instructions, information about new versions of the image diagnosis program or about rectifying errors are imparted to the user by the video.

The references to available videos are preferably displayed in the form of still references. This means that just the reference to the video, for example in the form of information symbol “i”, is displayed at the user interface until the user actively selects the video. Thus the video is not played automatically. The references and videos are selected and activated for example with the pointer of a computer mouse.

Advantageously a reference to at least one video can be integrated into at least one of the areas of the user interface listed below: Task area, (mini) toolbar, error message, context menu, information symbol, information area, control area or active display of information.

Advantageously a description of the respective initial situation is reproduced in the video. This makes it easier for the user to decide whether viewing the video is worthwhile in the respective situation, i.e. whether it would help him further in the respective situation. Furthermore background knowledge can be advantageously imparted thereby, which an un-trained user would possibly not have. Furthermore it is advantageous for at least the major operating steps of an operating process to be reproduced in the video. It is especially advantageous for all operating steps to be reproduced in detail. However this increases the length of a video. In addition references to further optional operating steps can be reproduced in the video, for example references to alternate operating steps or alternate problem solutions.

Preferably the operating steps etc. are described acoustically i.e. by an acoustic reproduction of the information. Also preferably the operating steps are described optically, for example by a reproduction of faithful or stylized descriptive images. The video thus contains, in an especially preferred form of embodiment, both sound and also image information. For further simplification of the information imparted by means of the inventive videos a subtitle can be reproduced when the video is played. This enables additional image information to be provided. This is especially advantageous if it is not possible to play the sound information.

To guarantee that the information is imparted in the most compact possible way and to design the videos to be as user-friendly as possible, said videos advantageously have a duration of 60 s to 90 s at most, preferably 30 s to 40 s at most. This additionally strictly limits the time outlay for the user.

In a further form of embodiment, a listing of all videos stored in the processing unit can be displayed. This gives the user a simpler overview of the available videos. For example he can view a video of interest irrespective of the specific application and thus explicitly expand his knowledge.

The inventor, in at least one embodiment, further proposes improving a processing unit of a medical imaging system, especially of a CT system or an MRT system, at least comprising a memory unit and program code stored in the memory unit, wherein the program code is designed such that a medical image of a patient is output at a user interface of the processing unit, to such an extent that at least one embodiment of the inventive method described herein is able to be executed.

Finally the inventor proposes a medical imaging system, especially a CT system or an MRT system at least having an inventive processing unit described herein.

Overall various advantages may be obtained with various embodiments of the invention:

The very application-specific and context-related videos enable the content to be reduced to the actual context in which the user finds himself. This simplifies the information imparted and reduces the time expended by the user. In such cases a context-specific video can explain not just the individual function or an individual tool but can give the user an overview of a number of tools and functions which are needed as part of an operating step.

The videos are adapted explicitly and specifically to the respective situation and are only offered in this specific situation in the work area. As a consequence not all videos are offered at once, which would be very unclear for the user, but only context-specific videos tailored to the working (sub)step or to the respective error message.

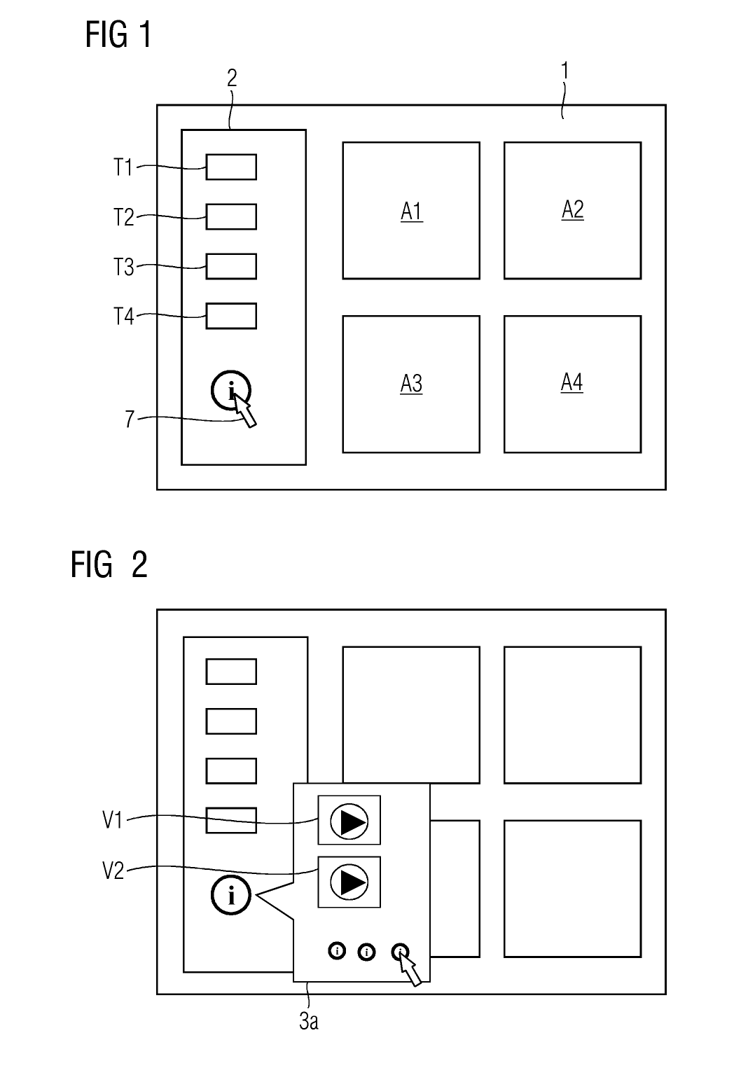

FIGS. 1 to 4 show, in a typical exemplary embodiment, the steps for carrying out an embodiment of the inventive method for retrieval of information at a user interface. Shown in the figures in each case is a user interface 1 of a processing unit of a medical imaging system. Shown at the medical interface 1 in each case are four different views A1 to A4 of a medical image of an examination object. Furthermore a toolbar 2 with four tools T1 to T4 available to the user is shown in the left edge area of the user interface 1. In accordance with an embodiment of the invention a reference to a number of videos stored on the processing unit and integrated into the user interface 1 is also shown in the toolbar. The reference is displayed here in the form of an information symbol i.

FIG. 1 shows a first step of an embodiment of the inventive method. If the user needs specific information about a particular working situation, for example about drawing a center line through particular areas of the examination object displayed in the views A1 to A4, the user activates the reference to the stored videos. The reference is activated by the user positioning the pointer 7 of a computer mouse on the “i” symbol. This opens a window 3a at information symbol i, see FIG. 2. Displayed in the window 3a are the respective stored, context-specific videos V1 and V2. Also displayed in the window 3a are further references to additionally available videos for similar working situations.

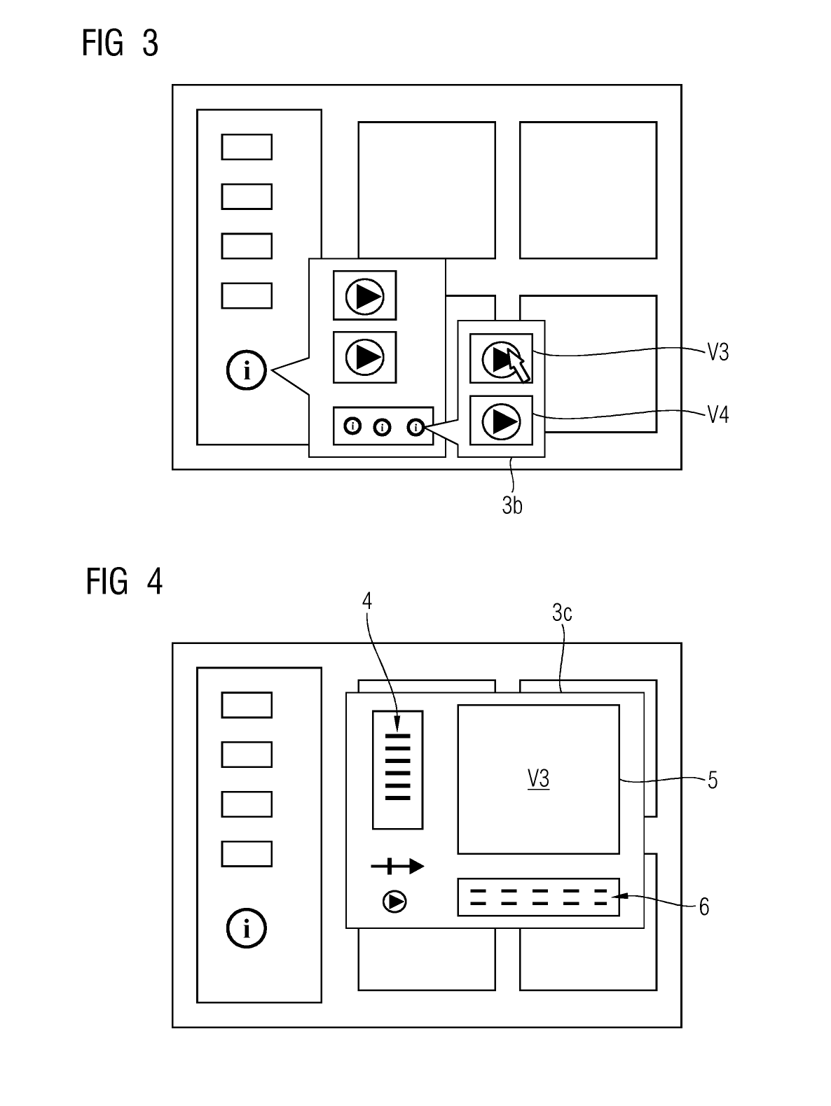

By activating one of the further references a further window 3b is opened. In this window 3b the videos V3 and V4 for the similar working situation are displayed, see FIG. 3. The user can then play one of the stored videos V3 or V4. In accordance with the invention the selected video V3 contains demand-specific and context-related information and operating instructions for the user.

To play the video a further window 3c opens at the user interface, see FIG. 4. In this window 3c both the video V3 is played to the user in a specific area 5 and also all working steps which are described in the video V3 are presented. Furthermore a subtitle 6 is reproduced. The video V3 additionally contains an acoustic reproduction of the initial situation and the working steps to be performed by the user.

Although the invention has been illustrated and described in greater detail by the example embodiment, the invention is not restricted by the disclosed examples and other variations can be derived herefrom by the person skilled in the art, without departing from the scope of protection of the invention.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, tangible computer readable medium and tangible computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a tangible computer readable medium and is adapted to perform any one of the aforementioned methods when run on a computer device (a device including a processor). Thus, the tangible storage medium or tangible computer readable medium, is adapted to store information and is adapted to interact with a data processing facility or computer device to execute the program of any of the above mentioned embodiments and/or to perform the method of any of the above mentioned embodiments.

The tangible computer readable medium or tangible storage medium may be a built-in medium installed inside a computer device main body or a removable tangible medium arranged so that it can be separated from the computer device main body. Examples of the built-in tangible medium include, but are not limited to, rewriteable non-volatile memories, such as ROMs and flash memories, and hard disks. Examples of the removable tangible medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for retrieval of information relating to a medical image presented at a user interface of a processing unit of a medical imaging system, comprising:
displaying a reference to at least one video stored on the processing unit and integrated into the user interface;
activating the reference and selection of the video by a user; and
playing of the video, wherein the video contains at least one of demand-specific and context-related information and operating instructions for the user.

2. The method of claim 1, wherein a reference to at least one video is integrated at least into one of the areas of the user interface including: Task area, toolbar, error message, context menu, information symbol, information area, control area or actively displayed information.

3. The method of claim 1, wherein a description of a respective initial situation is reproduced in the video.

4. The method of claim 1, wherein at least a main working step of a working process is reproduced in the video.

5. The method of claim 4, wherein references to further, optional working steps are reproduced in the video.

6. The method of claim 1, wherein a subtitle is reproduced in the video.

7. The method of claim 1, wherein the video is played with a duration of at most 60 s to 90 s.

8. The method as claimed in claim 1, wherein a list of all videos stored in the processing unit is displayed.

9. A processing unit of a medical imaging system, comprising
a memory unit; and
program code stored in the memory unit, wherein the program code, when executed by the processing unit, causes the processing unit of the medical imaging system to implement the method of claim 1 to output a medical image of a patient at the user interface of the processing unit.

10. A medical imaging system, comprising:
the processing unit of claim 9.

11. The method of claim 4, wherein all working steps of a working process are reproduced in the video.

12. The method of claim 2, wherein a description of a respective initial situation is reproduced in the video.

13. The method of claim 2, wherein at least a main working step of a working process is reproduced in the video.

14. The method of claim 13, wherein references to further, optional working steps are reproduced in the video.

15. The method of claim 2, wherein a subtitle is reproduced in the video.

16. The method of claim 7, wherein the video is played with a duration of at most 30 s to 40 s.

17. The medical imaging system of claim 10, wherein the medical imaging system is a CT system.

18. The medical imaging system of claim 10, wherein the medical imaging system is an MRT system.

19. A computer readable medium including program segments for, when executed on processing unit of a medical imaging system, causing the processing unit of the medical imaging system to implement the method of claim 1.
